(19) United States
(12) Patent Application Publication
(10) Pub. No.: US 2004/0078330 A1
(43) Pub. Date: Apr. 22, 2004

(54) Method and apparatus for auditing billing accounts

(76) Inventor: Glen Steven Henry, Birmingham, AL (US)

Correspondence Address: Dykema Gossett, PLLC, Suite 300 West, 1300 I Street, N.W., Washington, DC, 20005-3306, US

(21) Appl. No.: 10/640,658

(22) Filed: Aug. 14, 2003

Related U.S. Application Data
(60) Provisional application No. 60/404,929, filed on Aug. 22, 2002.

(51) Int. Cl. G06F 17/60

(52) U.S. Cl. 705/40

(57) ABSTRACT

A method and apparatus for analyzing bills submitted to various clients by service providers without disclosing confidential information. Each service provider is identified by a unique identifier and billing information is stripped of confidential information. Hours expended and expenses are compared with selected criteria for each client. The expenses and charges which exceed respective client criteria are identified and flagged for review. The apparatus may be implemented in an on-line environment.

### CROSS REFERENCE TO RELATED APPLICATION

This application is related to Provisional Application Serial No. 60/404,929 filed Aug. 22, 2002, the teachings of which are incorporated herein by reference.

### BACKGROUND OF THE INVENTION

The invention pertains to a method and apparatus for auditing on a confidential basis, time and charges submitted by various service providers to one or more clients. In particular the invention pertains to a method an apparatus for testing client tolerance levels for hours and expenses submitted by service providers such as law firms in such a way that confidential client information is not inadvertently disclosed.

Fraud plagues the property and casualty industry. It comes in many forms and from many sources. Unfortunately, it too often comes from the very sources one would least expect. Regardless of its origin, results are the same. In 2002 alone, insurance industry analysts reported fraud losses of $30 billion. In the property and casualty insurance industry fraud affects policyholders, shareholders, company executives and public opinion and perception of insurance companies. Fraud may be committed at different stages by insurance applicants, policyholders, third party claimants and even the professionals hired by companies to assist and protect them. Insurers spend hundreds of millions of dollars each year in an attempt to identify the sources, reduce the impact and, hopefully, eliminate the fraud. Some forms of fraud however, are almost impossible to track. Chief among these is fraud in legal billing by counsel.

Much has been researched and written about fraud in hourly billing. Birmingham Alabama's Cumberland School of Law Professor William G. Ross is the most prolific legal author in the world on the subject of ethical abuses in legal billing. His books, The Honest Hour: The Ethics of Time-Based Billing By Attorneys and Legal Fees, Law and Management, co-authored with John W. Toothman, provide exhaustive coverage on the subject of billing fraud. His writings in law reviews further establish the immense proportions of the problem. Billing abuses by counsel are virtually indigenous to the system, and the methods used to take advantage of the system are as varied as the lawyers employing them.

Major corporations and in particular insurance companies use services of law firms throughout the world to handle lawsuits and claims submitted by injured parties. Typically a submitted claim is turned over to a local law firm where the claim originates. The firm then handles the defense or settlement of the matter. Firms specializing in insurance defense work may be engaged by more than one insurance company or more than one corporate claims department.

It is not unusual, especially where a client is a major insurance company or corporation, for the law firm to have a special arrangement with such client. For example, certain routine services may be handled on a flat rate basis while other services, such as conducting a trial may be handled on an hourly basis. In addition, it is expected that the client will reimburse the firm for ordinary and necessary expenses incurred in connection with handling any particular matter.

Major clients often times require billing statements which provide detailed information as to the date of service, nature of the service provided, the attorney performing the work and the hours spent performing such services. In addition, detailed information as to expenses is likewise required by such clients. The client thus has some measure of control over the costs for any particular matter and has a way to question the accuracy of the billing statement.

Difficulties arise when service providers (attorneys) bill a particular client for time and expenses on a particular day, and also bill another client for time and expenses on the same day. Presumably, if the service charges are billed at an hourly rate, no one individual service provider (attorney A) should bill more than a certain number of hours in any twenty-four hour period. For example, if attorney A spends eight hours trying a matter in a local court, it is unlikely that the same attorney would also be able to bill eight hours of trial time to another client on the same day. Thus, if one could look at the billing statements for each client correlated with each service provider, the date and the services, as well as the time expended, one would have a method for more accurately checking the accuracy of billing statements.

In the above example, while, a sixteen hour billing day may not be usual, it is possible. On the other hand, it is not likely that a particular attorney would be trying two cases on the same day. Therefore, if one could examine the hourly reports of each service provider for each client, unusual and unlikely entries may be flagged for investigation. Also, if on a particular day, the chargeable hours for any individual provider exceed twenty-four hours or a pre-set tolerance limit, the charge could be flagged as an anomaly.

Likewise, disbursements expended on behalf of more than one client should be allocated among the various clients for whom the disbursements are expended. For example, if a service provider travels to a location to conduct business for two or more clients, the charges should be allocated. Therefore, if billings for disbursements to different clients are compared, it is possible to detect whether each client is being charged a proper allocable share of the particular disbursement.

Too many lawyers contend that any additional scrutiny requested by insurers could jeopardize their ability to provide the best possible defense for their clients. Attorneys' primary objection centers on the argument that increased oversight by insurers will breach the attorney-client privilege. Many disagree. Moreover, for the unethical or unscrupulous attorney, the protection afforded under confidentiality precepts provides the means to bill multiple insurers for duplicate hours and expenses, or even for fabricated time. Neither auditors nor litigation managers have the ability to overlay, or compare, an attorney's hours and expenses with the bills submitted to other insurers represented by that particular attorney.

Clients do not have access to the billing information of third parties. Such access is not available because the billing information is considered confidential. The confidentiality pertains not only to business information, but also pertains to legal issues.

If business information is revealed to a third party, the result may be unfortunate. However, if the information releases to legal issues, it is possible that the attorney/client privilege may be waived. Accordingly, any system which allows for such analysis of billing data must preserve confidentiality.

### SUMMARY OF THE INVENTION

The present invention is based upon the discovery that billing statements received by one or more clients may be examined on a confidential basis in order to determine billing and expense anomalies.

According to the invention, there has been provided a method for analyzing bills submitted to various clients from diverse service providers. The billing information may contain confidential and non-confidential information. The analysis takes place without disclosing or compromising the confidential information by identifying each individual service provider, each client, and the services provided by encoded identifiers. Also, expenses charged are likewise encoded. The date of the service and details of each expenditure are analyzed as well. The billing information may be filtered or encoded to remove confidential information or to mask the information. According to the method billing and expense anomalies are flagged for investigation by the responsible client. Criteria for identifying said billing and expense anomalies are established in accordance with the tolerance level of each individual client.

### BRIEF DESCRIPTION OF THE DRAWINGS

FIG. 1 is a schematic block diagram illustrating a limitation of the method according to the invention.

FIG. 2 is schematic block diagram of an apparatus for implementing the present invention.

FIG. 3 is a schematic diagram showing an hours audit feature of the invention.

FIG. 4 is a schematic diagram showing an expressed audit feature of the invention.

FIG. 5 is a block diagram illustrating an embodiment of the invention implemented in a web based environment.

FIGS. 6-8 illustrates an alternative overview of the problem and COBIS solution

### DESCRIPTION OF THE INVENTION

The present invention is a Codified Overlay Billing Information System (C\overline{O}BIS). Until the present invention, insurers relied predominantly on internal and outside auditors, litigation managers and special investigation units (SIUs) to control the impact fraud has on their loss and loss adjustment expenses. SIUs are focused primarily on claim fraud.

Twenty-eight hours in a day seems impossible. If an attorney (for a specific day) bills a client company 4 hours it seems completely reasonable. However, if he bills (for the same day), 4 hours to 7 different insurers, 28 hours a day is not difficult and without the present invention, such abuse will go undetected. C\overline{O}BIS can accumulate individual attorney hours and expenses, by day, for each and every insurer. Litigation management and auditing cannot.

Insurers have utilized auditors in an effort to monitor legal expenses and increase claims management efficiency. They review and make recommendations for payment or nonpayment of defense counsel's billings based on compliance or noncompliance with billing procedures and guidelines which have been adopted by a particular company in coordination with the planned outsourcing of billing reviews to be performed by the audit company. Relying heavily on standards, averages, historical means, and on-the-job experience formulated to serve as a template for usual and customary charges, auditors have provided insurers with a single method to reduce expenses. Attorneys have long argued that auditors succeed only in reducing hours. Inflating their bills will easily offset the inevitable reductions.

Litigation managers have grown in great numbers during the last decade. These managers offer a broad range of services. Their sophistication has grown with ever-increasing databases of historical claims and expense information. Using the comparative statistical information yielded from these databases, they have done a great job of controlling, projecting and monitoring individual insurers' performance in relation to industry benchmarks. A large number of these companies are led by former insurance company claims executives and offer objectivity and counseling to insurers looking for ways to reduce legitimate expenses and claims. The invention is not strictly speaking an auditor or litigation management service. It is designed to detect fraud.

Statistical data provides a basis for the anticipated savings the invention will generate. According to a recent Tillinghast report, “U.S. Tort Costs: 2002 Update, Trends & Findings on the Costs of the U.S. Tort System”, tort costs increased 14.3% in 2001, the highest percentage increase since 1986. The study found 14% to 15% of these costs were directly attributable to defense costs. A variety of expenses were included in those calculations, such as experts, accident reconstruction specialists and third party adjusters. Extensive research indicates that as much as 50% of such defense costs are attributable to legal fees and expenses. The fees and expenses paid to lawyers as part of the $205 billion U.S. tort system cost for 2001 is conservatively estimated to have exceeded $18 billion.

In 2002, the property and casualty insurance industry had net written premiums of approximately $325 billion with an average loss ratio, including all loss adjustment expenses, of around 80% (79.5%). This equated to a total for all U.S. insurers of $260 billion in Loss and All Loss Adjustment Expenses (L & ALAE). Research indicates that 7% of L & ALAE is paid to insurance defense firms for fees and expenses. Consequently, in 2002, the industry's legal costs easily exceeded 2001's $18 billion, and conservative estimates for 2003 indicate that over $20 billion will be paid to lawyers.

Dishonest billing by counsel has been heretofore undetectable. Unscrupulous attorneys can employ a variety of methods for over-billing that are virtually impossible to detect through post-billing scrutiny. Unethical billing practices of unscrupulous counsel may affect as much as thirty percent (30%) or more of total billings. By double, triple or multiple billing, padding or fabricating hours, recycling work, billing associate or paralegal time as partner time, stacking time or using other creative methods, counsel have beaten the system consistently for decades. Through the effective use of the invention, however, even assuming that only half that percentage can be reduced, savings to the property and casualty industry could exceed $2.7 billion annually.

C\overline{O}BIS is a most advanced way to protect company assets from fraud. Through Internet enabled time entries and automated overlays of defense counsel's periodic bills to multiple companies, C\overline{O}BIS can provide a selected periodic cumulative hours and expenses billed by any counsel employed by a participating company. The integration of C\overline{O}BIS into the checks and balances of insurance companies worldwide will reduce the fraud traditionally employed by unscrupulous counsel. C\overline{O}BIS will provide a company with that overlay and the ability to identify the offenders, to reduce the financial impact and to eventually eliminate the abusive billing practices. The system does not affect the use of traditional auditing methods.

THE SARBANES-OXLEY ACT mandates responsibilities never before seen in corporate America. With COBIS, it is possible to obtain Sarbanes-Oxley verification that a company is doing all it can to protect investors. Because C\overline{o}BIS is a window into billing practices never before opened, risks associated with assumptions about abusive billing need not be made. C\overline{o}BIS will provide the necessary information.

According to the invention, a C\overline{o}BIS.US has been established to a secure website which conforms to the National Security Agency's guidelines and vaults company data. C\overline{o}BIS employs a secure configuration of the Apache Web Server, Apache Server Version 1.3.3 on Red Hat Linux 5.1 Lawyers will input their billing data at this site. It will mirror the hard copy or electronic bill remitted to the participating company, but will not disclose confidential or privileged information. The C\overline{o}BIS system will not require any additional staff or software modifications. Because C\overline{o}BIS is an “ASP” codified overlay billing index system; its codes allow detection of information among fields that have heretofore been untraceable because of confidentiality considerations. The member company requires counsel to input codes on the C\overline{o}BIS website. Inputting may be minimal or by automatic/electronic input via counsel's billing entry software. The company will simply confirm a file's total time and expenses whenever the hard copy or electronic bill is sent.

The codes allow C\overline{o}BIS, as an industry third-party clearinghouse, to collect information on a cumulative basis without disclosure of either the insured client's identity or the nature of the tasks being performed by counsel on behalf of the insured. Disclosure of such information has historically been prohibited by ethical considerations, but with its codes, the invention enables a method of tracking that protects the privileged information. Attorneys, policyholder's names, the nature of the claim and the actual legal work performed are not readily discoverable by viewing the codes input into the C\overline{o}BIS website.

C\overline{o}BIS takes the codified information and stacks it electronically according to attorney and firm. Since billing cycles among the many member companies may vary significantly, attorney totals may not include all daily, weekly, monthly or yearly billable hours for a year or more. Thus, actual detection of abuses may not be known in the same year as they occur. But abuses will eventually be uncovered. Their reduction or absence, however, will mean one thing—that C\overline{o}BIS will have effectively eliminated the abuses it was designed to prevent.

Electronic stacking of information, the overlay, will allow cumulative time totals to be determined at any time. A member company will select time and expense(s) tolerances that will trigger Internet alerts once those tolerances have been reached or exceeded. For instance, if the company sets attorney tolerance at 15 hours per day, 75 hours per week, 250 hours per month and 3,000 hours per year, counsel's habitual billing of 14 hours per day may avoid the daily tolerance, but will show up eventually. C\overline{o}BIS and member companies recognize that lawyers may have legitimate totals that exceed pre-set tolerances. The ultimate question is whether habitually excessive totals are legitimate.

Member companies will require counsel to enter the attorney identification code, file number, dates of services rendered, and time and expense for each task or block of time billed to the company. Entry of the codes on the C\overline{o}BIS website will take seconds per task or block to perform. If entry is automatic/electronic through counsel's billing software, no additional time for entry will be required. Thus little remaining of the administrative task will be required of counsel for the C\overline{o}BIS entry. Upon receipt of counsel's hard copy or electronic bill, the member company will then simply confirm a file's total time to the total input by counsel into C\overline{o}BIS.US.

C\overline{o}BIS will electronically monitor totals from that point. And while prospective avoidance of C\overline{o}BIS abuse monitoring may be achieved by counsel actually entering non-abusive/legitimate cumulative totals, counsel cannot undo the past. Companies desiring retroactive detection can also retain C\overline{o}BIS for determination of past abuses. Whenever abuses are detected, each company to whom time has been billed during the period involved is notified. Confirmation of the time and/or expense totals may be made through C\overline{o}BIS by member companies under an express agreement to cooperative with one another. Confirmation will also be effected without disclosure of insured identity or task confidentiality.

Any member company may determine its own course of action with regard to abusive counsel or firms discovered. The effectiveness of C\overline{o}BIS as a legal bill clearinghouse increases with each new member and eventually only non-members will face the flagrant abuses of the past. Ultimately, all companies concerned with profits, compliance and security will use C\overline{o}BIS as the industry's source for billing fraud and abuse protection.

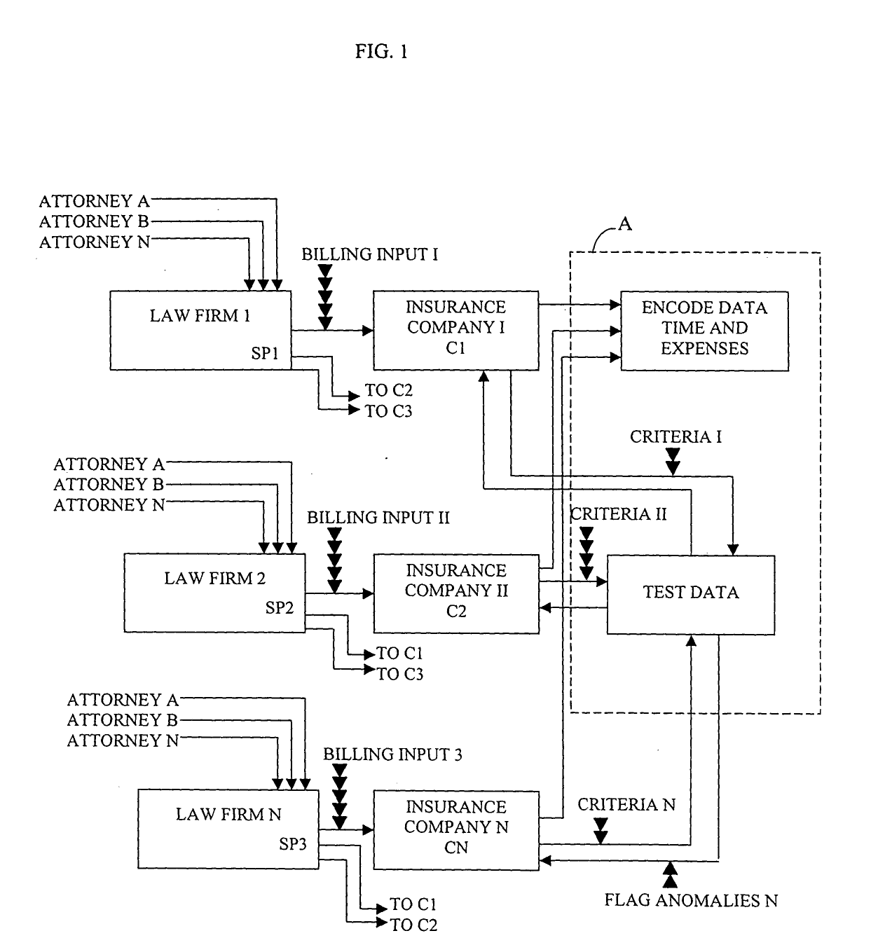

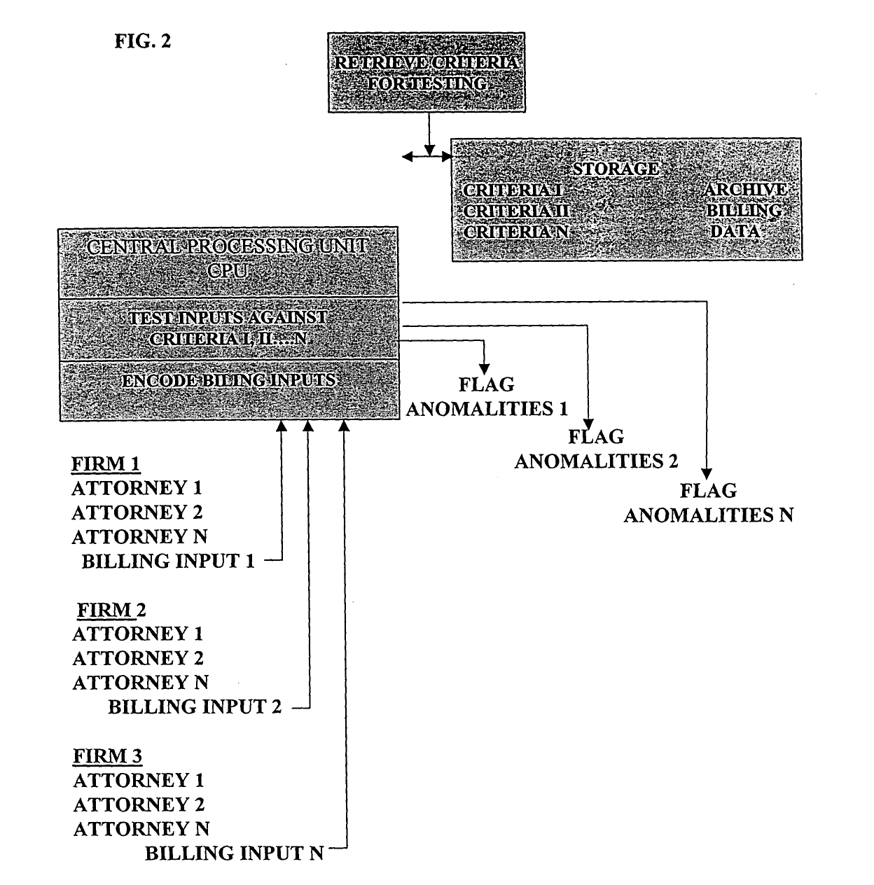

FIG. 1 illustrates in schematic block form a representative implementation of the present invention. Although the invention is described in the context of insurance defense services, other implementations are possible.

One or more clients or member companies C1-CN, e.g. insurance companies, assign work to request legal services from one or more service providers, SP1-SPN e.g. law firms. The service providers each provide the services and submit an invoice upon completion for the work. Each client is then free to analyze and question any obvious errors. However, in order to more fully analyze the data, each client submits its invoice data to an auditor A. The billing data from each client is selectively encoded by the auditor A to identify in a confidential manner each client, and to identify as well, upon request by the clients, the services provided by each service provider. The dates of service and the time charged for the services are tabulated. In addition, if as usual there is more than one individual service provider or attorney in a firm, each individual service provider's time, dates of service and expenses are broken down.

A similar encoding and break down of disbursements may be made, for example, if an individual service provider incurred travel expenses on a certain day, those expenses would be listed and encoded to identify the type of expense (e.g., airline tickets) and destination and cost and level of service may be optionally added. If the same individual service provider incurred travel expenses for two clients on the same day, such expenses or disbursements would be encoded as well.

The encoded data is then tested against selected criteria established by each client. If the charges or disbursements exceed the levels established by selected criteria for a particular client, a flag is set and that information is communicated to the client as a basis for investigation. The client may then submit the item to the service provider requesting further explanation or justification for the charge.

Table I below illustrates in the simplified form an example of a printout showing flagged and non-flagged items from the auditor.

TABLE 1

| | | | | | TOT- | |
|---|---|---|---|---|---|---|
| FIRM 1 | CLIENT | DATE | HOURS | SERVICE | AL | FLAG |
| ATT. 1 | I | Jan. 2, 2003 | 7 | MISC. | 14 | Y |
| ATT. 1 | II | Jan. 2, 2003 | 7 | MISC. | 14 | N |
| ATT. 2 | I | Jan. 2, 2003 | 3 | TRIAL | 8 | Y |
| ATT. 2. | II | Jan. 2, 2003 | 5 | TRIAL | 8 | Y |
| ATT. 2 | II | Jan. 2, 2003 | . . . | TRIAL | 10 | N |
| | | | | PREP | | |
| ATT. 2 | II | Jan. 2, 2003 | | TRIAL | 3 | N |
| | | | | PREP | | |
| ATT. 3 | II | Jan. 2, 2003 | 4 | TRAVEL | 4 | Y |
| ATT. 3 | III | Jan. 2, 2003 | 4 | TRAVEL | 4 | Y |

As illustrated in the table attorney 1 of firm 1 provided services on 1-2-03 to client I charging seven (7) hours for miscellaneous legal services. The same service provider or attorney provided service to client II and charged seven (7) hours on the same date, namely 1-2-03.

In accordance with the invention it is possible that client I might wish to challenge billings for attorney 1 at firm 1, inasmuch as that the individual service provider billed out 14 hours in one day. While this is possible, it may be unusual. Accordingly, depending upon the criteria set by each client, a 14 hour charge may or may not be challenged. In the exemplary illustration the 14 hour charges raise a flag for client I. The same charge does not raise a flag for client II.

Attorney 2 of firm 1 provided services on 1-2-03 to client I in the amount of three (3) hours and likewise provided services for client II on the same day in the amount of five (5) hours for a total of eight hours for the day. The 8 hour charge for attorney 2 is not flagged by either client.

In the above example, it is also possible that the 14 hour charge may not be flagged if there is some other criterion of overriding. For example, client I may not flag the 14 hour charge, if it is the only such charge in the particular billing period. Likewise weekend and weekday charges may have different flagging criteria.

Table II below shows an exemplary illustration of a disbursements audit printout.

TABLE II

| | CLI- | | | | | |
|---|---|---|---|---|---|---|
| FIRM 1 | ENT | DATE | EXPENSE | TYPE | RCPT. TOT. | FLAG |
| XTT. 3 | II | Jan. 2, | $ 400.00 | TRAVEL | $ 800.00 | N |
| | | 2003 | | NY-DC | | |
| ATT. 3 | III | Jan. 2, | $ 400.00 | TRAVEL | $ 800.00 | N |
| | | 2003 | | | | |

The disbursement expense is incurred by attorney 3 of firm 1 to client II for 01-02-03. In this case attorney 3 claims an expense for travel from New York to Washington. The disbursement is $400.00. Although not shown in the table, details such as the flight number and class of service may be noted. On the same day attorney 3 claims a disbursements of $400.00 for client III showing the same destination, flight number, and class of service. The total charge for the expense therefore is $800. The column designated receipt total for receipts submitted indicates that the total expense is $800.00. Therefore it appears that the travel expense was allocated, or divided equally between the clients.

The above example shows that the airfare was properly allocated among the clients. However, Table I shows that the travel time was incurred by Attorney 3 two clients were charged the same number of hours namely 4 hours, on the date in question. If the travel time total is only 4 hours, than both clients II and III were charged for the entire travel time. This gives rise to a time anomaly, in as much as it appears that the travel was double billed. Therefore, a flag is raised on the time audit but it is not raised on the expense audit.

It is contemplated that the auditor would be a third party having a contract for auditing services with a number of clients including insurance companies and large corporations. These companies would agree to provide billing information to the auditor along with flagging criteria. The auditor, having access to confidential information from a variety of companies, some of which may be competitors and adversaries, maintains the billing information from each company or client in a confidential database. The information may be encoded in such a way that someone looking at the data would not know the identity of the individual company or the particulars of the substantive nature of the services provided. For example, a billing statement from a law firm may contain a detailed description of the services provided, including perhaps names of individuals and details about the services rendered. The confidential information would be stripped from the data and only that which is necessary for a thorough analysis of the billing records would be used. Alternatively, the confidential information could be encoded into a comparative database. The encoded information would then be tested against the individual criteria established by each company. Flagged data is reported to each client and the billing data may be archived to provide a history. Indeed, the archived data may be implemented to update and adjust the various criteria in an interactive manner.

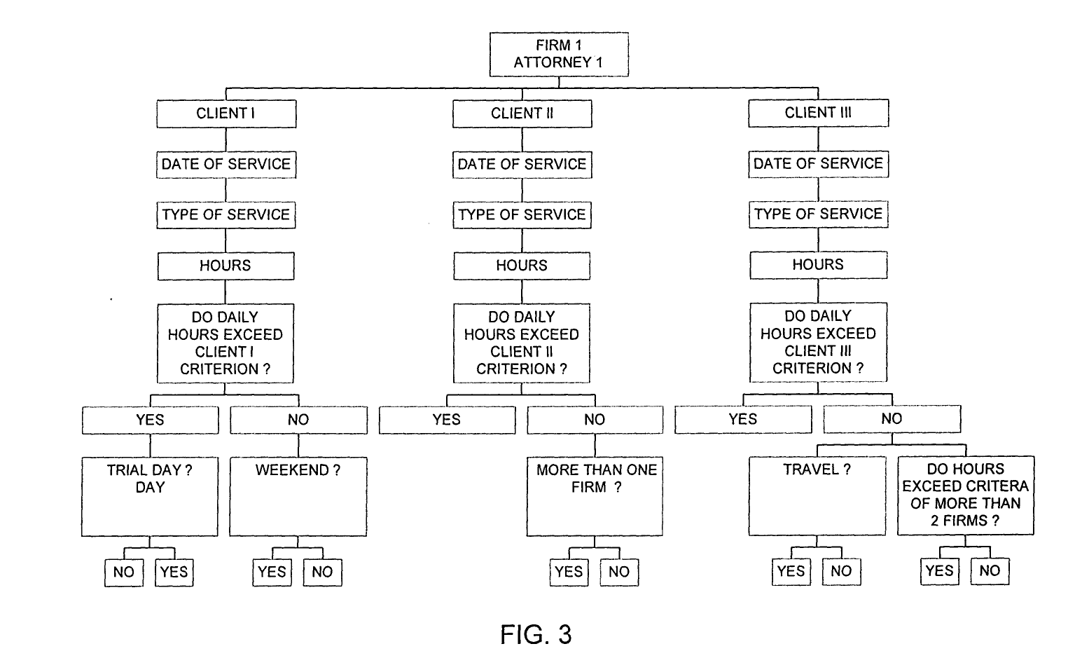

An important feature of the invention however is that billing information provided by various service providers to various clients may be compared in a manner which does not violate confidentiality or obviate the attorney client privilege, and at the same time, allows for a comparative analysis of the data. A simple flow chart is illustrated in FIG. 3 where it can be seen that the service audit is made as to the date, the identity of the attorney and the total number of hours billed per day. It matters not whether this audit is for one or two clients, because the number of hours does or does not exceed some limit for the day. Alternatively, there could be a limit depending on he type of service. For example, in Table I trial time in court may be limited to a specified number of hours. Trial preparation limits may be different particularly if a trial is under way. In the example, trial time appears to be doubled billed and then a flag is raised. The trial prep time is not flagged because even though the hours are high, the prep time is occurring on a trial day and higher than normal prep time is to be expected.

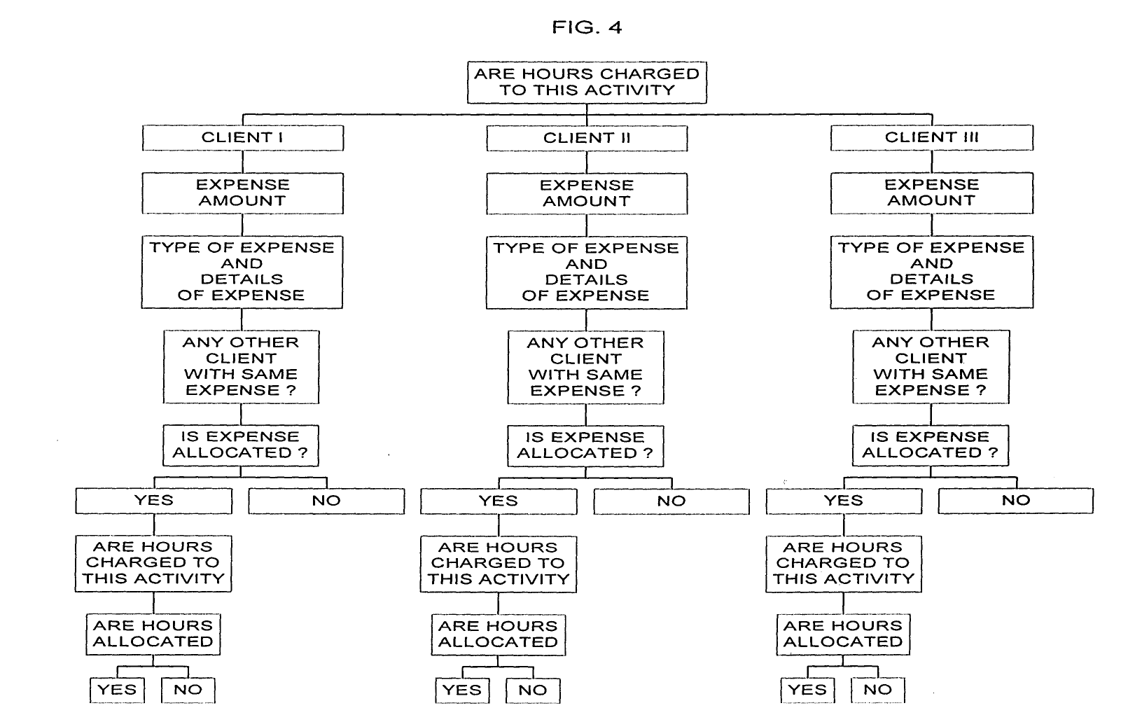

It should be understood that various criteria may be implemented. In addition, various scenarios may be contemplated to allow the auditor to evaluate the data different ways so that the audit procedure is flexile and adaptable, rather than being a purely mechanical calculation. If however, if it is desired to vary the criteria, such that the limits are either increased or decreased depending on the number of clients involved, that my be provided as illustrated in the flow chart of FIG. 4.

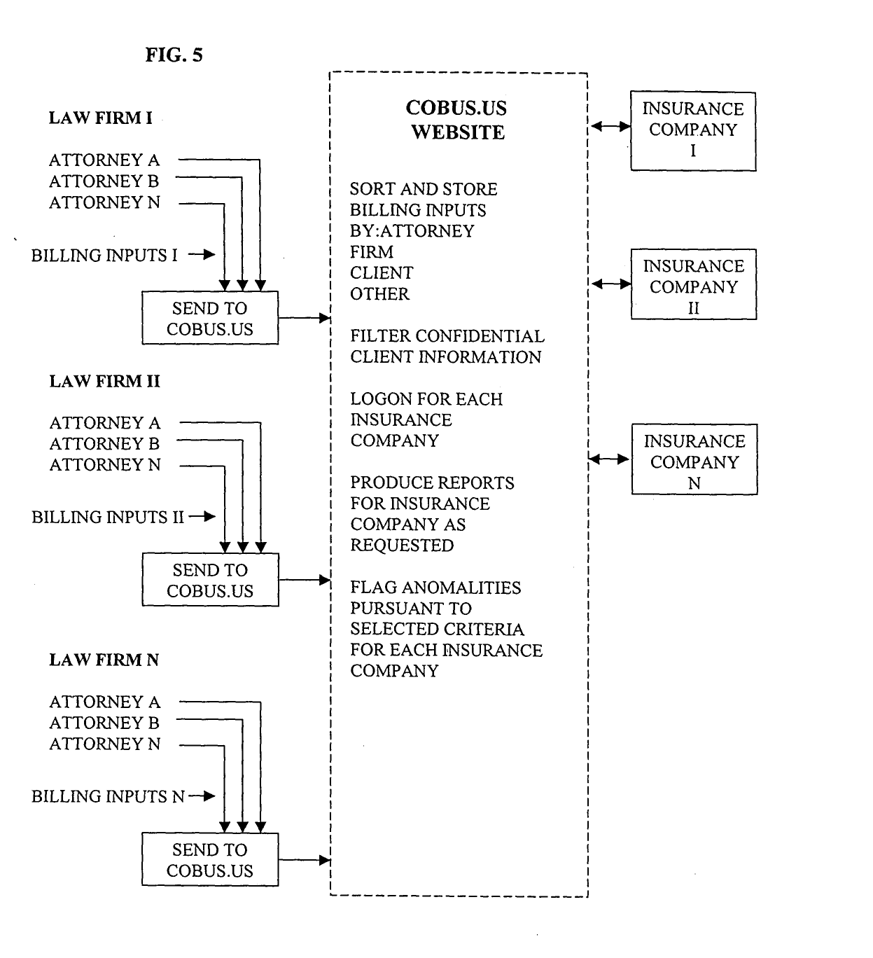

FIG. 5 illustrates another embodiment of the invention employing a web based feature. According to the arrangement illustrated, each attorney in a particular law firm enters time and billing information into the firm information system in a conventional manner. The billing inputs from the various attorneys are sent to a secure website COBUS.US. The website sorts and stores the information according to a variety of criteria including, for example, by lawyer. Other storage criteria may be employed as shown. The information is processed to filter confidential information, or to assign confidential codes to the data so that the clients are not identifiable by unauthorized parties. Each insurance company has a secure access to the website by a logon code or other appropriate means. Each insurance company may request reports as to the time and billing recorded for each attorney and firm. Anomalies are flagged in accordance with criteria selected for each firm. As noted earlier, each company may have different tolerance levels for different services and disbursements. The arrangement of FIG. 5 is designed to simplify the implementation of the system in the environment of network based information systems.

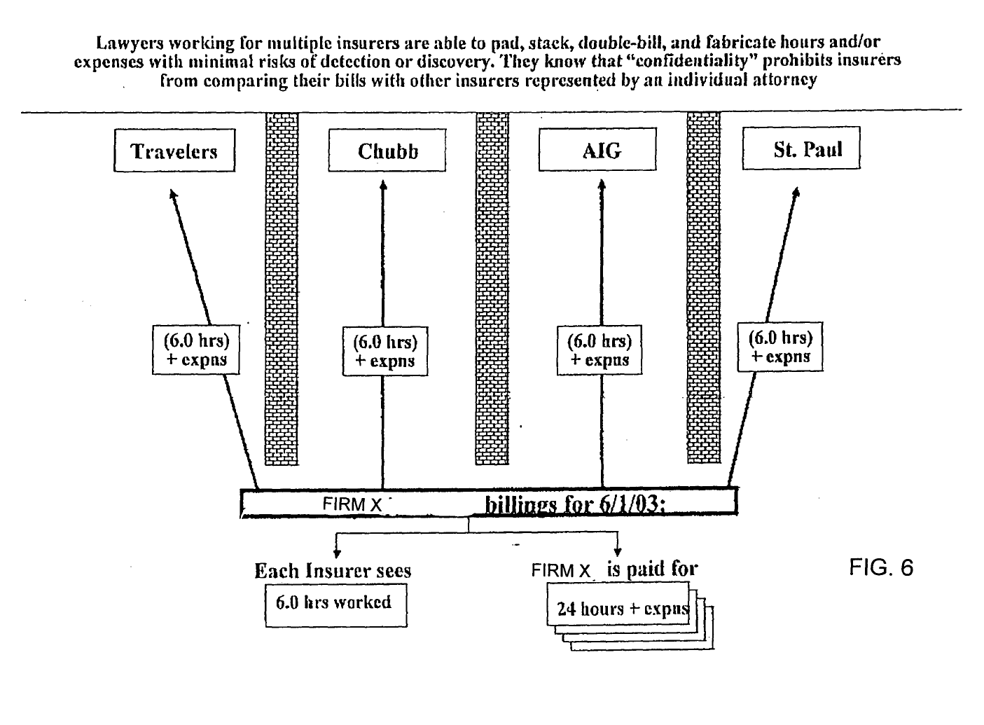

FIG. 6 illustrates an example of excess billing in a 24 hour period. Law firm X's (Attorney A) billings for one day is six (6) hours for each of four (4) clients. The total, 24 hour billing, is unacceptable. Accordingly, the 24 hour billing is flagged.

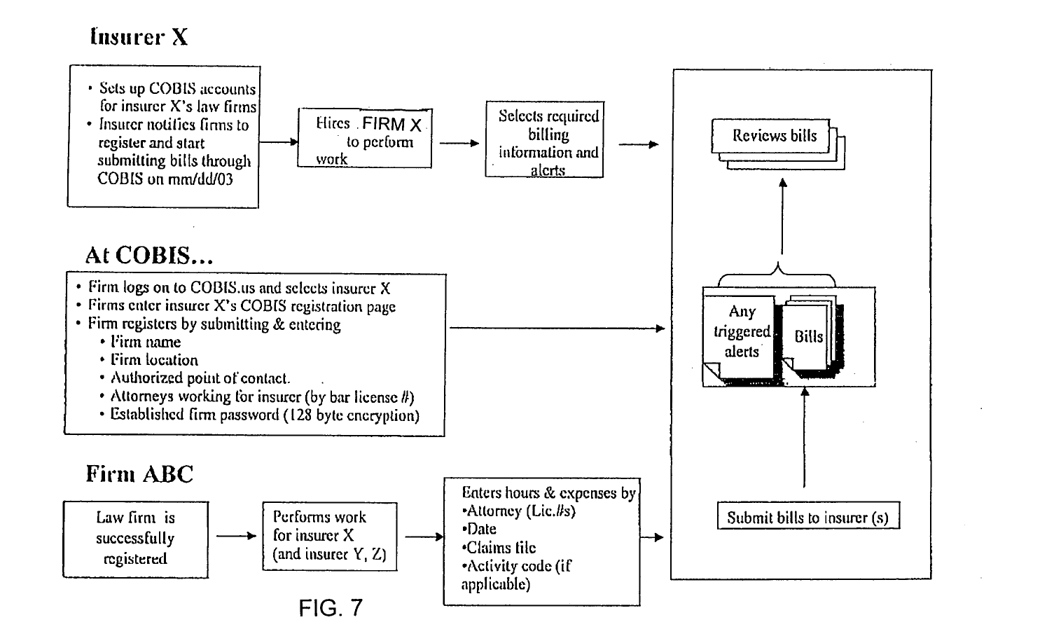

FIG. 7 illustrates an embodiment of the CoBIS system in which the insurer sets up a C\overline{o}BIS account, engages a firm and instructs the firm to use C\overline{o}BIS for entering billing data. The firm enters the required data, which is reviewed by C\overline{o}BIS.

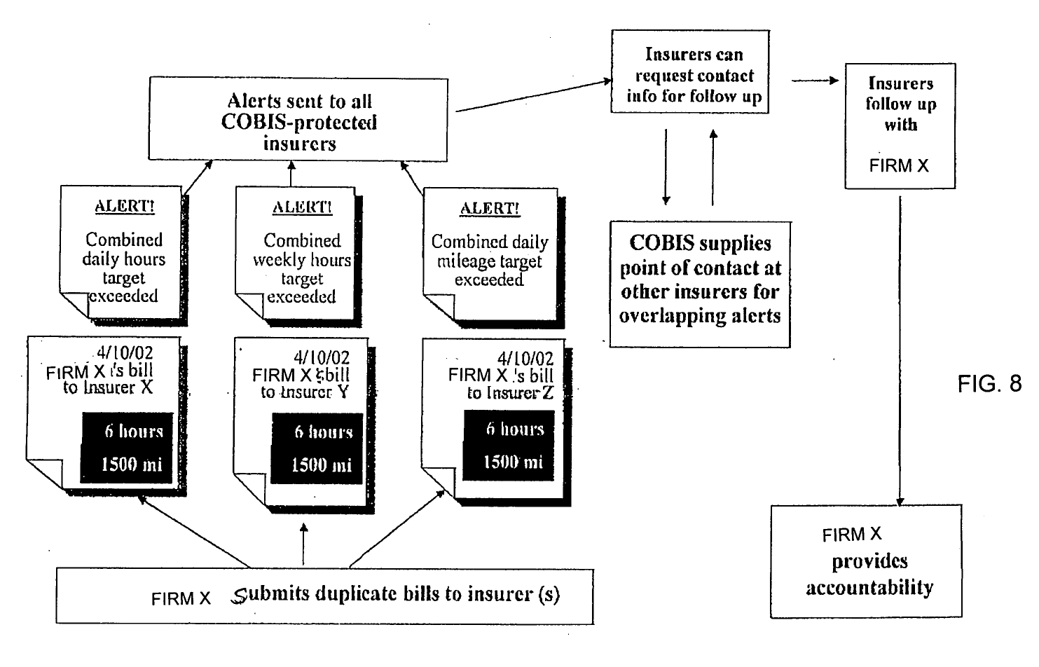

In FIG. 8, the analyzed data provides alerts based on exceeded daily target or weekly target or both, and mileage targets. Duplicate bills submitted to C\overline{o}BIS member insurers X, Y, Z triggers alert based on targets. The alert causes participating member companies to request explanation of changes and results in accountability.

While there has been described what at a present are considered to be the exemplary embodiments of the invention, it will be apparent to those skilled in the art that various modifications and changes may be made therein. It is intended in the attached claims to cover such changes and modifications as fall within the true sprit and scope of the invention.

What is claimed is:

1. A method for analyzing bills transmitted to various clients from diverse service providers having one or more individual service providers without disclosing confidential information of the various clients comprising the steps of:
identifying each individual service provider by a unique identifier;
identifying each client by a unique identifier;
identifying the date of service;
identifying the hours of service for each provider;
establishing criteria for a maximum level of chargeable hours for each client;
comparing total hours of hours of service for each said individual service provider with a selected maximum level of chargeable hours for each of said clients; and
flagging the entry for communication to a client when the total number of hours exceeds the maximum level of chargeable hours for each client respectively.

2. A method for analyzing billing information containing charges submitted to various clients from individual service providers comprising the steps of:
removing confidential information from the billing information for each of the clients,
comparing the billing information with selected criteria indicative of a tolerance level for each respective client; and
flagging the billing information when the billing information contains charges which exceed the tolerance level for each client in accordance with the respective criteria.

3. The method of claim 2, wherein the charges comprise hourly billing charges.

4. The method of claim 2, wherein the charges include disbursements.

5. The method of claim 2 further including, varying the tolerance level in accordance with the selected criteria.

6. Apparatus for analyzing bills transmitted to various clients from diverse service providers having one or more individual service providers without compromising confidential information of the various clients comprising:
means for encoding information from the bills identifying the client, date of service and time charged by each provider; and means for analyzing the information for anomalies.

7. The apparatus of claim 6 where in the apparatus includes a network accessible by the service providers to input information.

8. The apparatus of claim 7 wherein the network is accessible by authorized auditors.

9. The apparatus of claim 6 wherein the apparatus includes a computer programmed to sort and store billing information, and to encode confidential client information and to analyze the billing information according to selected criteria for indicating anomalies.

10. A method on line analysis of the various clients from diverse service providers having one or more individual service providers without disclosing confidential information of the various clients comprising the steps of:
identifying each individual service provider by a unique identifier;
identifying each client by a unique identifier;
identifying the date of service;
identifying the hours of service for each provider;
establishing criteria for a maximum level of chargeable hours for each client;
forwarding via a network from the service provider to a server, the service provider information, client information, and at least one of time expended and disbursements expended by the service provider;
comparing total hours of hours of service or disbursements for each said individual service provider with a selected maximum level of chargeable hours for each of said clients; and
flagging the entry for communication to a client when the total number of hours or disbursements exceeds the maximum level of chargeable hours for each client respectively.

11. A method for on-line analyzing billing information containing charges submitted via a network to various clients from individual service providers comprising the steps of:
removing confidential information from the billing information for each of the clients,
comparing the billing information with selected criteria indicative of a tolerance level for each respective client; and
flagging the billing information when the billing information contains charges which exceed the tolerance level for each client in accordance with the respective criteria.

12. Apparatus for analyzing bills transmitted to various clients from diverse service providers having one or more individual service providers without compromising confidential information of the various clients comprising:
apparatus for producing the bills identifying the client, dates of service and time charged by each provider;
apparatus for transmitting the information to a server for remote analysis;
apparatus for encoding the bills to secure confidential client information; and
apparatus for analyzing the information for anomalies.

13. The apparatus of claim 12 including a network accessible by the service providers to input information.

14. The apparatus of claim 13 wherein the network is accessible by authorized auditors.

15. The apparatus of claim 12 wherein the apparatus includes a computer programmed to sort and store billing information, to encode the confidential client information, and to analyze the billing information according to selected criteria for indicating anomalies.

16. A method for analyzing bills transmitted to various clients from diverse service providers having one or more individual service providers without disclosing confidential information of the various clients comprising the steps of:
producing a bill by:
identifying each individual service provider;
identifying each client;
identifying the date of service;
identifying at least one of the hours of service and disbursements for each provider;
communicating the bills to a secure location via a service provider and client accessible network;
analyzing the bill at the secure location according to selected criteria for a maximum level of chargeable hours and disbursements for each client by:
comparing total hours of hours of service or disbursements for each said individual service provider with a selected maximum level of chargeable hours and disbursements for each of said clients; and
flagging the entry for communication to a client when the total number of hours or disbursements exceeds the maximum level of chargeable hours or disbursements for each client respectively.

17. The method or disbursement according to claim 16 further comprising the steps of:
removing confidential information from the bill for each client;
comparing the billing information with the selected criteria indicative of a tolerance level for each respective client; and
flagging the billing information when the tolerance level is exceeded.
